(19) United States
(12) Patent Application Publication
(10) Pub. No.: US 2025/0240744 A1
(43) Pub. Date: Jul. 24, 2025

(54) SINGLE SYNCHRONIZATION SIGNAL BLOCK (SSB) WAKE-UP FOR LOOP TRACKING ON UPLINK AND DOWNLINK BEAMS

(71) Applicant: QUALCOMM Incorporated, San Diego, CA (US)

(72) Inventors: Jun ZHU, San Diego, CA (US); Mihir Vijay LAGHATE, San Diego, CA (US); Yongle WU, San Diego, CA (US); Yong LI, San Diego, CA (US); Lei XIAO, San Jose, CA (US); Raghu Narayan CHALLA, San Diego, CA (US)

(21) Appl. No.: 18/420,409

(22) Filed: Jan. 23, 2024

(51) Int. Cl. H04W 56/00; H04W 52/52; H04W 76/28

(52) U.S. Cl. CPC H04W 56/0015; H04W 52/52; H04W 56/0065; H04W 76/28

(57) ABSTRACT

Certain aspects of the present disclosure provide a method for wireless communications at a user equipment (UE). The UE may receive a single synchronization signal block (SSB) during a synchronization signal burst set (SSBS) occurrence. The single SSB may include at least a physical broadcast channel (PBCH) and a secondary synchronization signal (SSS). The UE may perform a loop tracking task using the single SSB, based on a downlink serving beam and an uplink serving beam of the UE.

### BACKGROUND

### Field of the Disclosure

Aspects of the present disclosure relate to wireless communications, and more particularly, to techniques for managing loop tracking tasks of a user equipment (UE) using a single synchronization signal block (SSB).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes receiving a single synchronization signal block (SSB) during a synchronization signal burst set (SSBS) occurrence, wherein the single SSB comprises at least a physical broadcast channel (PBCH) and a secondary synchronization signal (SSS); and performing a loop tracking task using the single SSB, based on a downlink serving beam and an uplink serving beam of the UE.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIG. 4A, FIG. 4B, FIG. 4C, and FIG. 4D depict various example aspects of data structures for a wireless communications network.

FIG. 5 depicts example connected-mode discontinuous reception (CDRX) operations.

FIG. 6 depicts example CDRX with beamforming.

FIG. 7 depicts example CDRX with wake-up signals (WUS).

FIG. 8 depicts example CDRX with beamformed WUS.

FIG. 9 depicts example CDRX cycle with multiple synchronization signal burst set (SSBS) occurrences.

FIG. 10 depicts a call flow diagram illustrating example communication among a UE and a network entity.

FIG. 11 depicts example CDRX cycle with a single SSBS occurrence.

FIG. 12 depicts a method for wireless communications at a UE.

FIG. 13 depict example communications device.

### DETAILED DESCRIPTION

Aspects of the present disclosure provide apparatuses, methods, processing systems, and computer-readable mediums for managing loop tracking tasks of a user equipment (UE) using a single synchronization signal block (SSB).

For the UE to communicate with a new radio (NR) network, the UE needs to acquire necessary system information by performing cell search to find, identify, and synchronize with a specific cell. The UE may acquire such information via an SSB. The cell search is also essential for mobility, handover, and cell reselection purposes.

The SSB may consist of at least a primary synchronization signal (PSS), a secondary synchronization signal (SSS), and a primary broadcast channel (PBCH) channel. In NR, SSBs can be transmitted in different beams in a time domain. This set of the SSBs within a beam-sweep is known as an SS burst. The UE may only read the single SSB of a specific downlink beam, without taking into account any other SSBs transmitted from a same cell. In time domain, four orthogonal frequency division multiplexing (OFDM) symbols are used. For the SSB, the PSS is transmitted in a first OFDM symbol, the SSS in a third symbol, and the PBCH in second and fourth symbols.

A connected-mode discontinuous reception (CDRX) mode may enable the UE to turn off one or more components, such as a receiver, during certain periods (e.g., during an OFF duration of a CDRX cycle) because the UE is not anticipating receiving any communications. While the UE may not receive any communications during the OFF duration, the UE may still be expected to maintain certain information and connections with a gNodeB (gNB). For example, the UE may be configured to periodically perform cell search and measurement tasks (e.g., the searching of any cell resources available to the UE and the measuring of the quality of such resources), beam search and measurement tasks (e.g., the searching of any beam resources available to the UE and the measuring of the quality of such resources), and loop tracking tasks (sometimes referred to as “synchronization loops”) (e.g., the synchronizing of time tracking loops (TTLs), frequency tracking loops (FTLs), etc.). The performing of the loop tracking tasks may enable the UE to be synchronized with the gNB when the UE transitions from an OFF state to an ON state during, for example, the ON duration of the CDRX cycle.

The UE may use different beams for uplink and downlink operations, which may require loop tracking to be performed on two different beams (e.g., uplink and downlink beams of the UE) during the CDRX cycle. The loop tracking on the two different beams may need two synchronization signal burst sets (SSBSs) wake-up for the UE during the CDRX cycle (i.e., one SSBS for the loop tracking on the uplink beam and another SSBS for the loop tracking on the downlink beam), which consumes extra power by a battery of the UE for the SSBSs wake-up.

Techniques disclosed herein may help a UE perform multiple tasks during a same SSBS to reduce a number of wake-up SSBSs. For example, aspects may enable the UE to perform loop tracking tasks on uplink and downlink beams during a single SSBS (e.g., based on a single SSB received during the SSBS). The use of the single SSB for the loop tracking tasks may enable the UE to reduce the number of wake-up SSBSs from two or more SSBSs to one SSBS.

For example, the UE may use the downlink beam as an input to loop tracking on the single SSB to measure a TTL offset. The TTL offset measurement may use a PBCH associated with the single SSB, which may save an SSS symbol on the single SSB for other usage. The UE may use the uplink beam in the SSS symbol on the single SSB of the SSBS for the loop tracking (e.g., to measure a timing offset (TO)). The UE may adjust timing of uplink transmissions, based on the TTL offset and the TO. The UE may then send the uplink transmissions, during the ON duration of the CDRX cycle.

Particular aspects of the subject matter described in this disclosure can be implemented to realize one or more of the following potential advantages. In some examples, the described techniques may reduce power consumption by the UE and, thereby, may enable the UE to improve the power efficiency while operating in the CDRX mode. For example, when the UE may wake-up for fewer SSBS occurrences, the increased time between the wake-up SSBS occurrences helps to improve the power efficiency at the UE.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

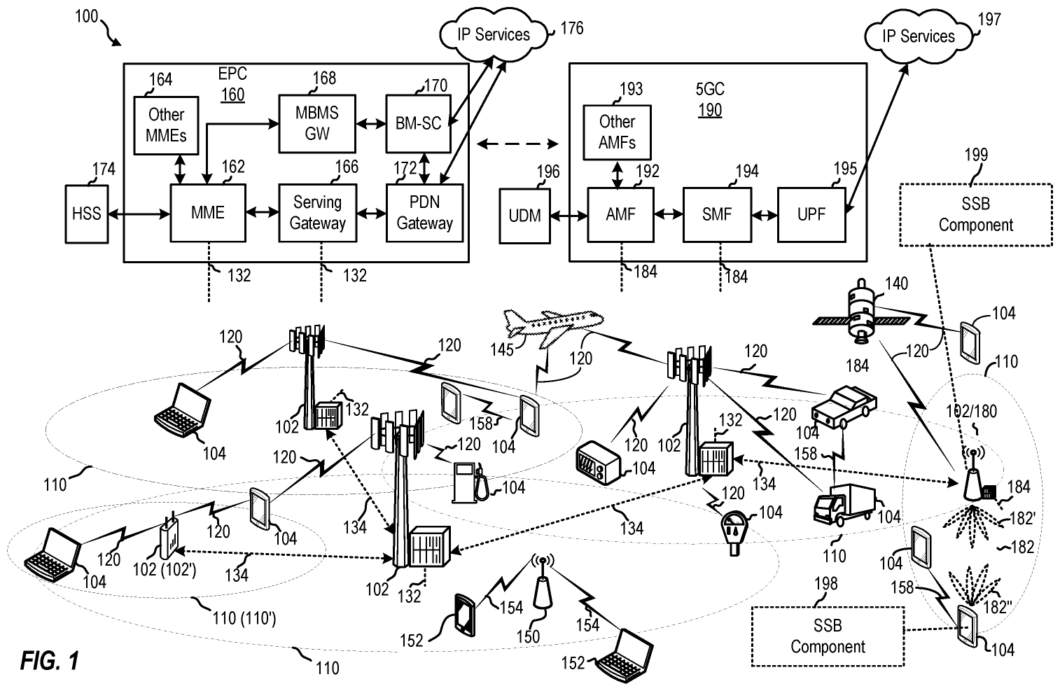

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

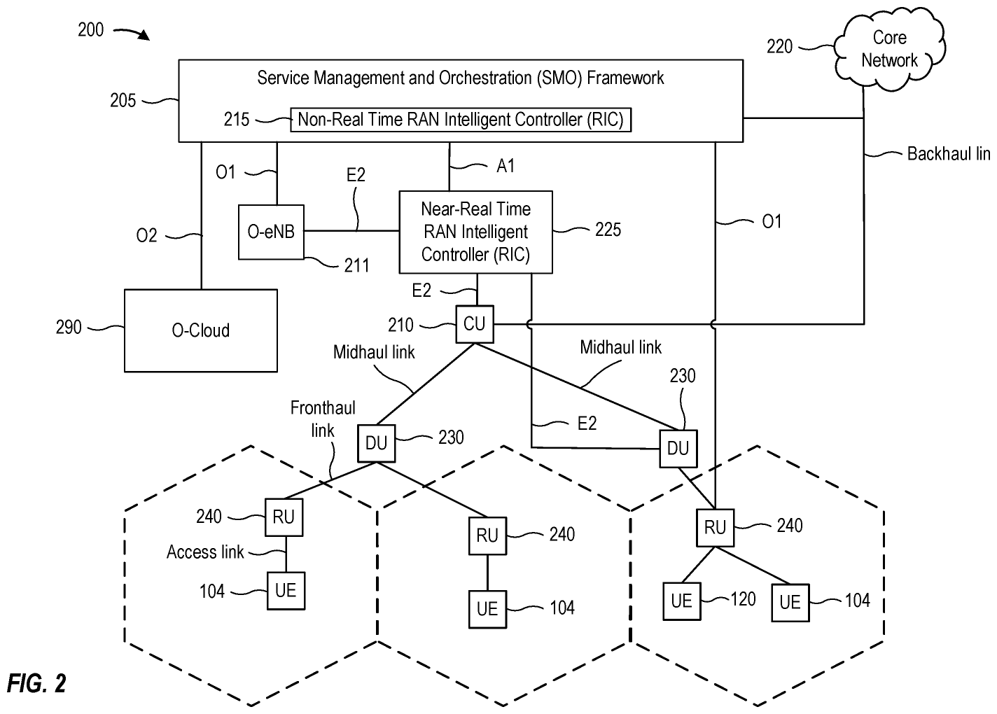

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

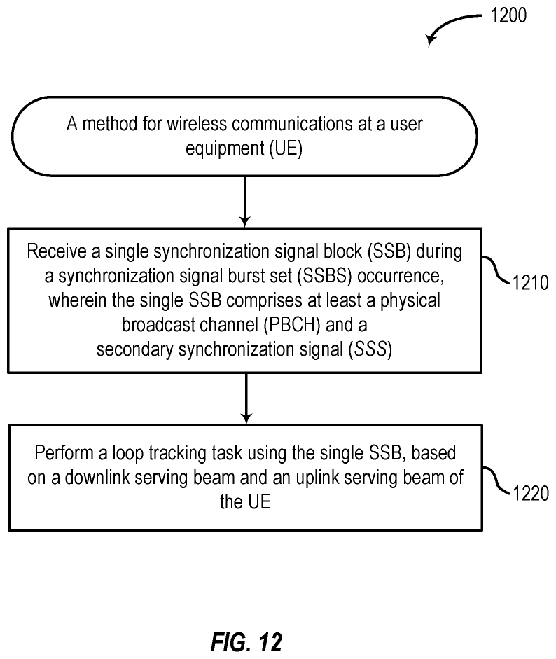

Wireless communication network 100 further includes synchronization signal block (SSB) component 198, which may be configured to perform method 1200 of FIG. 12. Wireless communication network 100 further includes SSB component 199, which may be configured to perform method 1200 of FIG. 12.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (Dus) 230 via respective midhaul links, such as an F1 interface. The Dus 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

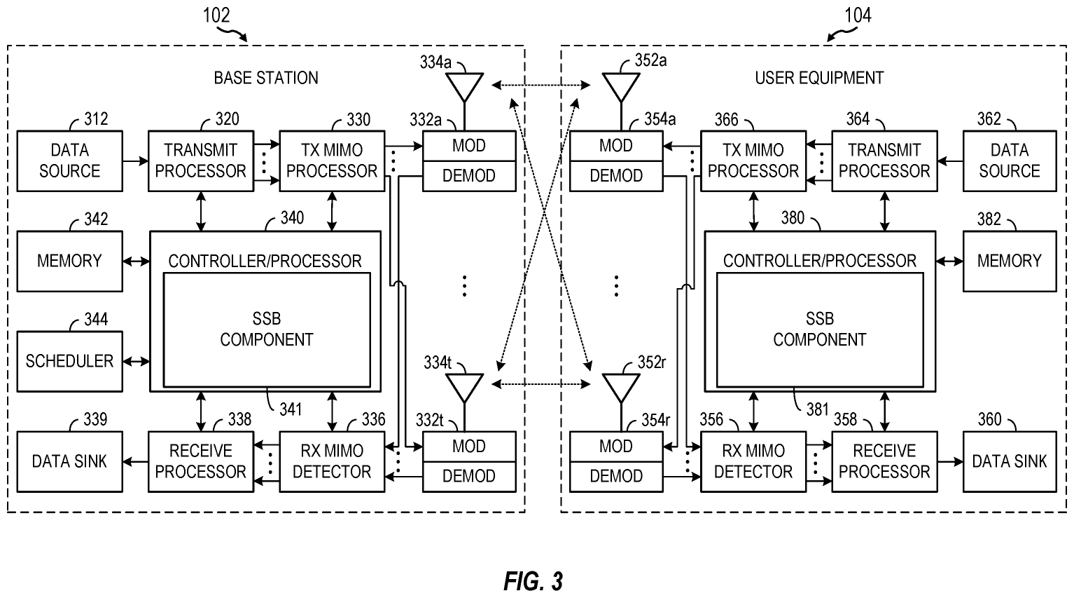

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes SSB component 341, which may be representative of SSB component 199 of FIG. 1. Notably, while depicted as an aspect of controller/processor 340, SSB component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes SSB component 381, which may be representative of SSB component 198 of FIG. 1. Notably, while depicted as an aspect of controller/processor 380, SSB component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of providing or outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

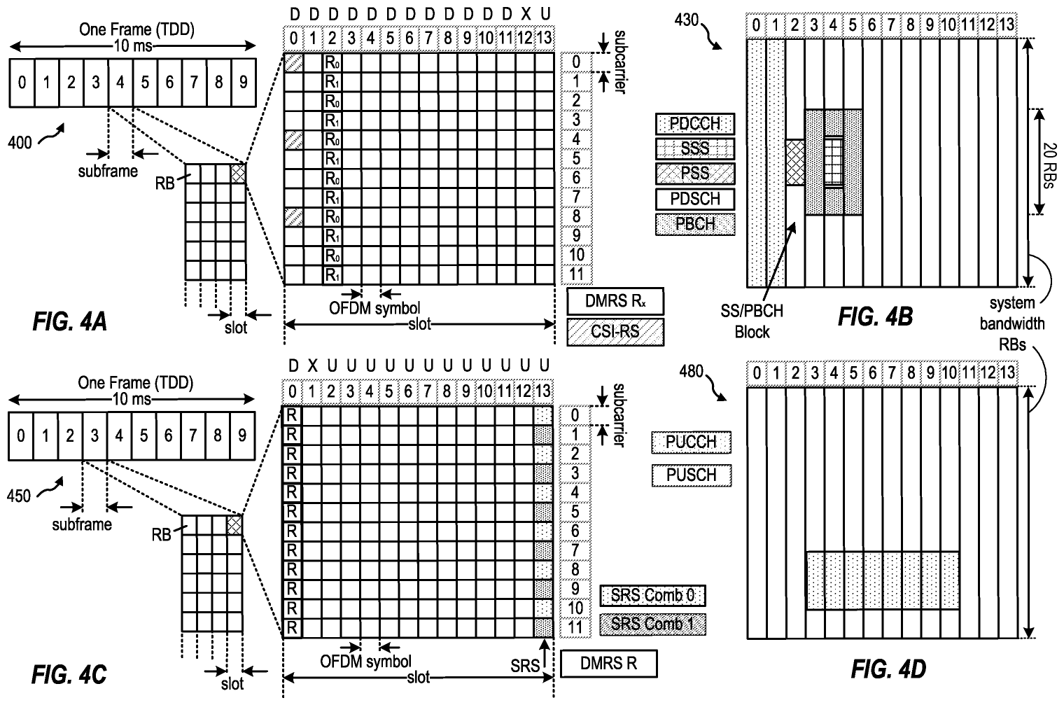

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3^{rd} generation partnership project (3GPP) standards. For example, 3GPP technical standard TS 38.101 currently defines Frequency Range 1 (FR1) as including 600 MHZ-6 GHZ, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Example Synchronization Signal Block (SSB)

When a user equipment (UE) is powered on or when it enters a new cell, the UE must be able to find the cell and synchronize to it in frequency and time. The UE must also be able to read some system information describing the cell in order to see if the cell can be used by the UE.

5G new radio (NR) uses synchronization signals such as a primary synchronization signal (PSS) with 3 different code sequences and a secondary synchronization signal (SSS) with 336 different code sequences. The synchronization signals enable the UE to find the cell along with helping the UE in synchronizing to the cell's timing. There can be 1008 (3×336) possible code sequences and a value in the PSS/SSS determines cell's physical cell identity (PCI). When the UE finds the synchronization signals, the UE can also read a physical broadcast channel (PBCH), whose location can be found around these synchronization signals.

Cell search also covers the functions and procedures by which the UE finds new cells. The procedure is carried out when the UE is initially entering the coverage area of a network system. To enable mobility, cell search procedure is also continuously carried out by UEs moving within the network system, both when the UE is connected to a network and when the UE is in idle/inactive state.

In order to perform an initial cell access in standalone (SA) mode, the UE needs to perform contention based random access procedure (CBRA) and therefore the UE needs to acquire relevant system information, which is system information block1 (SIB1). Accessing this information requires acquisition of master information block (MIB) and it's decoding. This is only possible while detecting and identifying a synchronization signal block (SSB). However, no information is provided in the SA mode to find the frequencies where the SSBs are transmitted, unlike non-standalone (NSA) mode where the UE receives the exact frequency location of the SSB via dedicated radio resource control (RRC) signaling.

The SSB consists of one orthogonal frequency division multiplexing (OFDM) symbol for the PSS and one OFDM symbol for the SSS. Furthermore, the SSB may contain two OFDM symbols for a primary broadcast channel (PBCH) which are identical. So, the SSB spans four OFDM symbols in a time domain and 240 subcarriers in a frequency domain. The PSS is transmitted in a first OFDM symbol of the SSB and occupies 127 subcarriers in the frequency domain. The remaining subcarriers are empty. The SSS is transmitted in a third OFDM symbol of the SSB and occupies a same set of subcarriers as the PSS. There are eight and nine empty subcarriers on each side of the SSS. The PBCH is transmitted within second and fourth OFDM symbols of the SSB. In addition, PBCH transmission also uses 48 subcarriers on each side of the SSS. The total number of resource elements used for PBCH transmission per SSB thus equals 576, which includes resource elements for the PBCH along with resource elements for the demodulation reference signals (DMRS) needed for coherent demodulation of the PBCH.

The PSS, the SSS, and the PBCH within the SSB are time multiplexed. The timing of the SSB can be set by a network. A default value of SSB transmission is 20 ms but can be set between 5 and 160 ms (5, 10, 20, 40, 80 and 160). During this time set by the network, a number of SSBs may be transmitted in different directions (called beams) during a 5 ms period. Each block of transmitted SSBs is referred to as an SS burst set. Although the periodicity of the SS burst set is flexible with a minimum period of 5 ms and a maximum period of 160 ms, each SS burst set may be confined to a 5 ms time interval, either in the first or second half of a 10 ms frame.

The PSS is a first signal that the UE entering a system will search for. At that stage, the UE has no knowledge of the system timing. Once the UE has found the PSS, it has found synchronization up to the periodicity of the PSS. The PSS extends over 127 resource elements and has 3 different PSS Sequences. Physical cell identity (PCI) of a cell determines which of the three PSS sequences to use in a certain cell. When searching for new cells, the UE must search for all three PSSs. Once the UE detects the PSS, the UE knows the transmission timing of the SSS. By detecting the SSS, the UE can determine the PCI of the detected cell. There are 1008 (3×336) different PCIs. However, already from the PSS detection the UE has reduced the set of candidate PCIs by a factor 3. There are thus 336 different SSSs, that together with the already-detected PSS provides the full PCI. The basic structure of the SSS is same as that of the PSS, i.e., the SSS consists of 127 subcarriers to which an SSS sequence is applied.

While the PSS and SSS are physical signals with specific structures, PBCH is a physical channel on which explicit channel-coded information is transmitted. The PBCH carries the MIB, which contains information that the UE needs in order to be able to acquire the remaining SI broadcast by the network.

### Example Discontinuous Reception (DRX) Operations

Discontinuous reception (DRX) is a power-saving mechanism used in communication systems to extend a battery life of a wireless node such as a user equipment (UE). The DRX mechanism may be used by UEs to periodically turn off their receivers and enter a low-power state, waking up only at specific intervals to check for incoming data or signals. This helps in reducing power consumption during periods of inactivity.

A DRX cycle defines a duration for which the UE remains in an active state before entering a low-power state. The DRX cycle may be divided into on-duration (active state) and off-duration (low-power state).

A long DRX cycle may refer to a DRX configuration with a longer cycle duration, which is suitable for scenarios where the UE can afford to stay in a low-power state for extended periods. A short DRX cycle may refer to a DRX configuration with a shorter cycle duration, suitable for scenarios where the UE needs to be more responsive and cannot afford long periods of inactivity.

In connected mode, where the UE is actively communicating with a network entity, connected-mode discontinuous reception (CDRX) allows the UE to periodically switch between active and low-power states. This is particularly useful when the UE expects incoming data but wants to conserve power during idle periods.

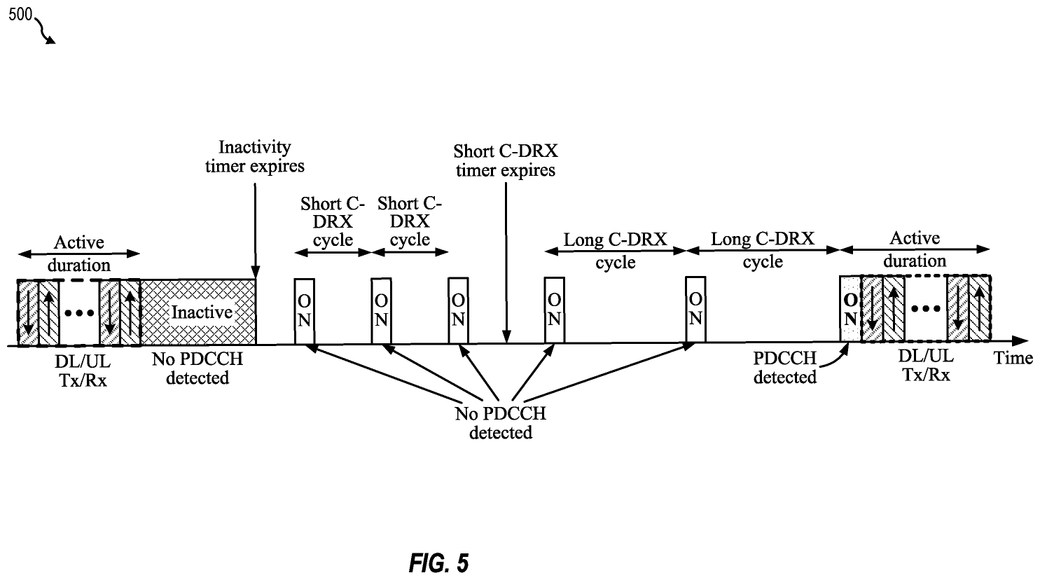

FIG. 5 depicts example CDRX operations. As illustrated in example timing diagram 500 of FIG. 5, during periods of traffic inactivity, a UE may switch to CDRX operation for power saving. In CDRX, when there is no data transmission in either direction (uplink (UL)/downlink (DL)) for a UE in an RRC connected mode, the UE goes into a DRX mode. In CDRX, the UE monitors a physical downlink control channel (PDCCH) channel discontinuously. In other words, the UE alternates between sleep (DRX OFF) cycles and wake (DRX ON) cycles. CDRX results in power savings because, without the DRX cycles, the UE would needlessly monitor for PDCCH transmissions in every subframe to check if there is downlink data available.

The UE may be configured for CDRX according to various configuration parameters, such as an inactivity timer, a short DRX timer, a short DRX cycle, and a long DRX cycle.

As illustrated in FIG. 5, based on configured cycles, UE wakes up occasionally for ON durations and monitors for PDCCH transmissions. Except for ON durations, the UE may remain in a low power (sleep) state referred to as an OFF duration, for the rest of CDRX cycle. During the OFF duration, the UE is not expected to transmit and receive any signal.

The UE may wake-up at a termination of CDRX mode. For example, if the UE detects a PDCCH scheduling data during an ON duration, UE remains on to transmit and receive data. Otherwise, the UE goes back to sleep at the end of the ON duration.

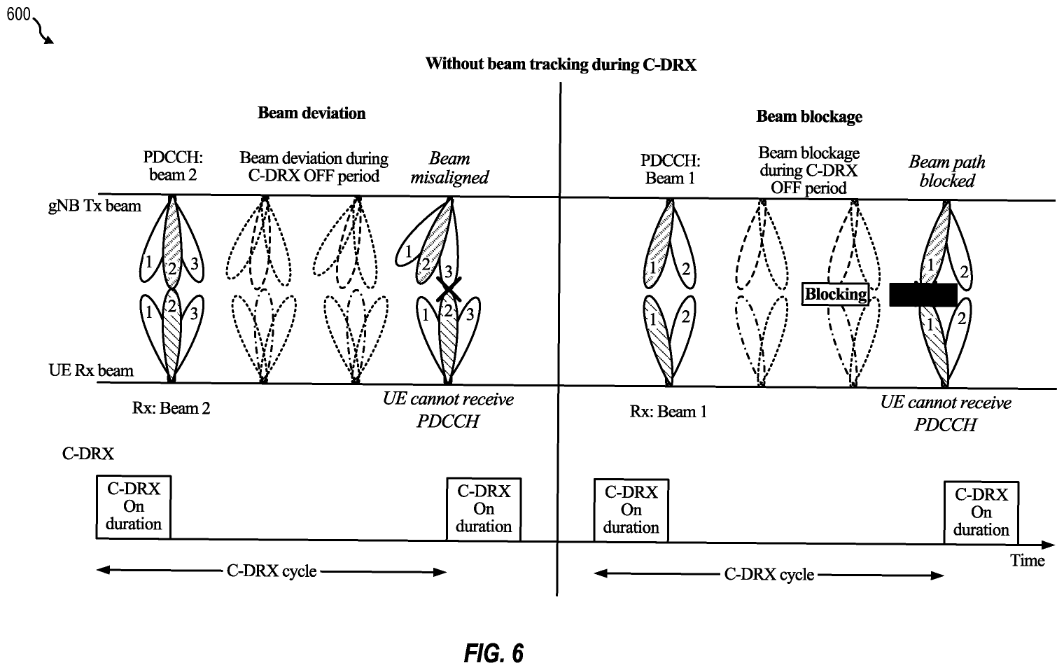

FIG. 6 depicts example CDRX with beamforming. As illustrated in example timing diagram 600 of FIG. 6, to enhance possibility or reaching a UE, beamforming may be used with the CDRX. While beamforming may enhance communications, it is not without challenges. For example, without beam tracking, beam pairs may degrade during a CDRX OFF period. The longer a CDRX cycle, the more vulnerable transmissions are to beam degradation. While shorter CDRX cycles may be less prone to beam degradation, shorter periods suffer from a power consumption penalty.

As illustrated in FIG. 6, due to beam deviation by UE orientation change or mobility (or beam blocking or maximum permissible exposure (MPE), etc.), the UE may not be able to receive PDCCH in the beginning of a next CDRX ON duration and fail to wake-up.

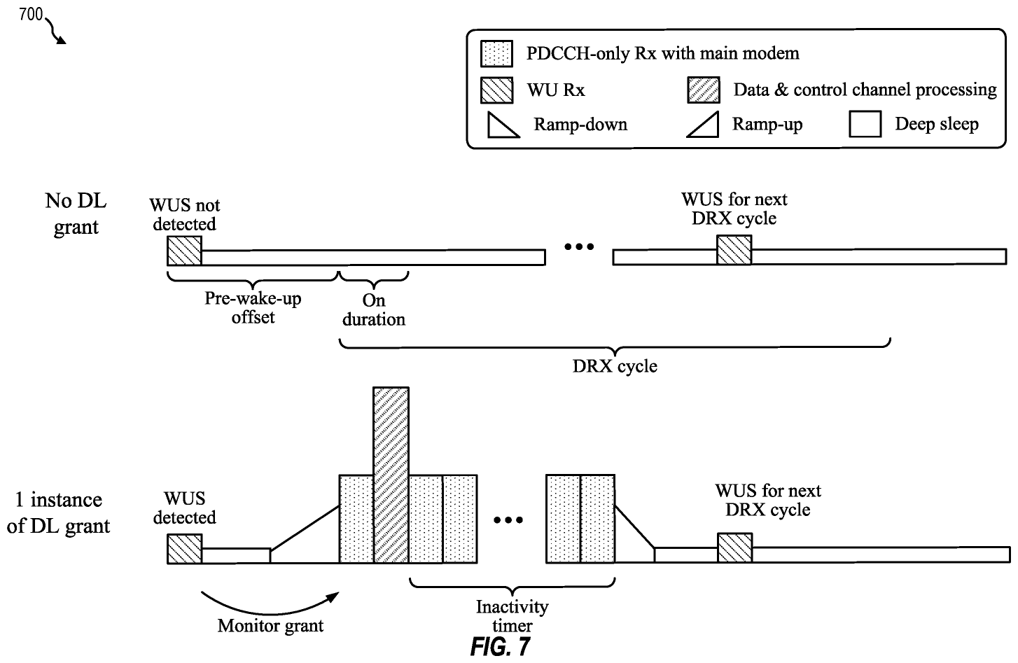

In some cases, sleep (OFF) durations may be extended using wake-up signals (WUS). The general principle of WUS in CDRX is illustrated in example timing diagram 700 of in FIG. 7.

As illustrated, before CDRX ON duration, only a wake-up subsystem is turned on for WUS decoding (e.g., while the main modem is not powered on). The wake-up subsystem is a low complexity receiver (e.g., a simple correlator) using a lower power than PDCCH decoding. The WUS may be a special waveform, such as special tone, preamble, reference-signal, or the like.

In some cases, only when WUS is detected, a UE wakes-up the full modem for the next ON duration. Otherwise, the UE skips ON duration and goes back to sleep until a next CDRX cycle.

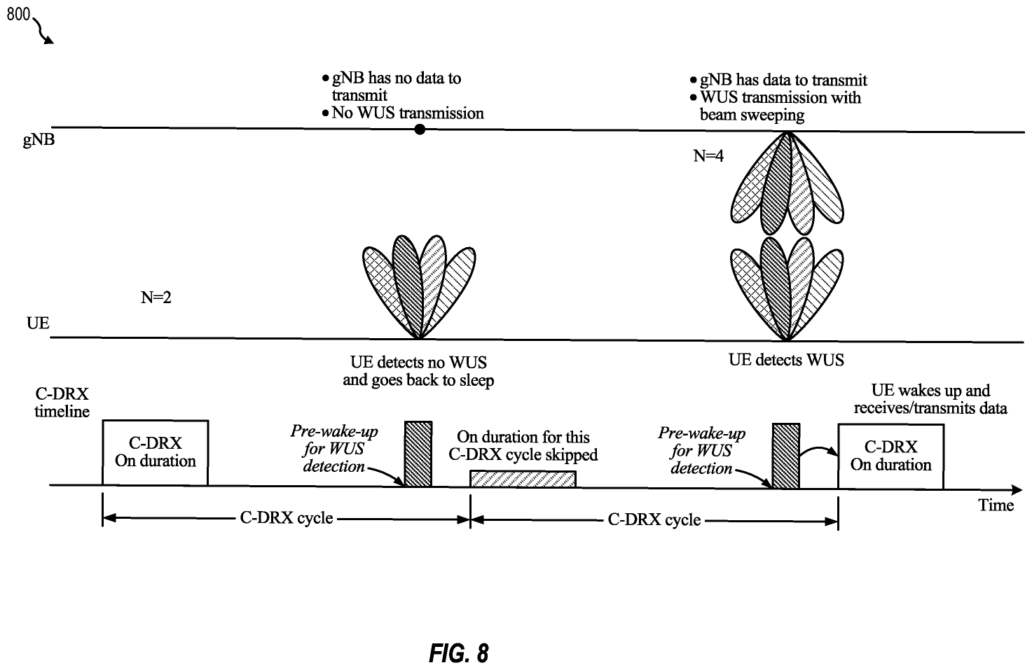

FIG. 8 depicts example CDRX with beamformed WUS. As illustrated in example timing diagram 800 of FIG. 8, beamforming may be applied to WUS transmissions. For example, a set of N (e.g., out of up to 64 synchronization signal blocks (SSBs)) beams may be configured for a UE. The value of N, and directions of the N beams, may be UE (or group)-specifically determined by gNodeB (gNB) (e.g., as a function of link quality, UE mobility, UE capability, CDRX cycle length, etc.).

### Example Loop Tracking and Other Tasks

One or more processors of a user equipment (UE) are configured to perform connected-mode discontinuous reception (CDRX) operations. For example, at times, the UE may operate in accordance with a CDRX cycle to conserve power. When operating in accordance with the CDRX cycle, the UE may wake-up and actively communicate with a gNodeB (gNB), during an ON duration of the CDRX cycle. The UE may then enter a sleep state during an OFF duration of the CDRX cycle. When the UE operates in the OFF duration of the CDRX cycle, one or more modulators-demodulators (modems) of the UE may be operated at a lower power level or turned off, and loops of the UE (e.g., automatic gain control (AGC) loops, time tracking loops (TTLs), frequency tracking loops (FTLs), power delay profile (PDP) loops, and/or channel estimation loops) may lose synchronization.

The AGC loop may be a closed-loop feedback regulating circuit in an amplifier or chain of amplifiers, the purpose of which is to maintain a suitable signal amplitude at its output, despite variation of the signal amplitude at the input.

The TTL may be used for re-verification of new radio (NR) time tracking error due to the sleep of the UE. The FTL may be used for re-verification of NR frequency tracking error due to the sleep of the UE. For example, the UE may operate a demodulation path that includes the TTL/FTL that can correct up to a certain amount of time or frequency shift due to multi-path or Doppler shift effect.

The PDP gives the intensity of a signal received through a multipath channel as a function of time delay. The time delay is the difference in travel time between multipath arrivals.

The CDRX mode may enable the UE to turn off one or more components, such as a receiver, during certain periods (e.g., during the OFF duration of the CDRX cycle) because the UE is not anticipating receiving any communications. While the UE may not receive any communications during the OFF duration of the CDRX cycle, the UE may still be expected to maintain certain information and connections with the gNB. For example, the UE may be configured to periodically perform one or more tasks, such as, cell search and measurement tasks (e.g., searching of any cell resources available to the UE and measuring of quality of such resources), beam search and measurement tasks (e.g., searching of any beam resources available to the UE and measuring of the quality of such resources), and loop tracking tasks (sometimes referred to as “synchronization loops”) (e.g., synchronizing of AGC loops, the TTLs, the FTLs, the PDP loops, and/or the channel estimation loops). The performing of the loop tracking tasks may enable the UE to be synchronized with the gNB when the UE transitions from an OFF state to an ON state during, for example, the ON duration of the CDRX cycle.

Synchronization signals, including synchronization signal blocks (SSBs) and synchronization signal burst sets (SSBSs), are reference signals that may be periodically transmitted by the gNB and received by the UE. The SSBS may include multiple SSBs, and each SSB may correspond to a different UE beam.

The UE may use the synchronization signals received during the OFF duration of the CDRX cycle to perform the one or more tasks in preparation for upcoming ON duration of the CDRX cycle. In some cases, the gNB may transmit the synchronization signals regardless of whether any particular UE is in the ON state of the CDRX cycle or waiting for the synchronization signals.

The UE may, during an SSBS, perform radio resource management (RRM), such as a search task and/or a measurement task, to search for any available cellular resources and/or beam resources and/or to measure the quality of any identified resources. The UE may also perform, during the SSBS, radio link monitoring (RLM) tasks to manage a link of any identified resources. The UE may also perform, during the SSBS, the loop tracking tasks to synchronize the loops of the UE (e.g., the AGC loops, the TTLs, the FTLs, the PDP loops, and/or the channel estimation loops).

The gNB may also transmit tracking reference signal (TRS) transmissions to the UE. The TRS transmissions may have a different periodicity and/or location than SSBS transmissions. In some cases, a location of a TRS occurrence may be positioned closer to a start of the ON duration of the CDRX cycle than a location of an SSBS occurrence. For example, the location of the TRS occurrence may be within a first time frame before a start of the ON duration of the CDRX cycle while the location of the SSBS occurrence may be within a second time frame before the start of the ON duration of the CDRX cycle and that is greater than the first time frame. In some cases, the location of the TRS occurrence may be closer to the start of the ON duration of the CDRX cycle relative to the location of the SSBS occurrence.

As noted above, the UE may perform, during the SSBS, the search and measurement tasks and the loop tracking tasks. In contrast to the SSBS, the UE may perform the loop tracking tasks during the TRS transmission (e.g., and may not perform the search and measurement tasks during the TRS transmission).

In some cases, a same UE beam may be applied to both uplink (UL) and downlink (DL) control and data channels in a millimeter wave (mmW) system. The same UE beam is a serving UE beam (SUB). For example, the UE may use or apply the SUB for periodical loop tracking tasks (e.g., on the SSB/TRS) for the PDP, the TTL, the FTL, and/or the AGC update.

In some cases, during a CDRX mode, the TRS may be absent. That is, the UE may not receive any TRS from the gNB during a CDRX cycle. So, when the UE is in the CDRX mode, the UE may need to fully rely on the SSBs from the gNB for the loop tracking tasks.

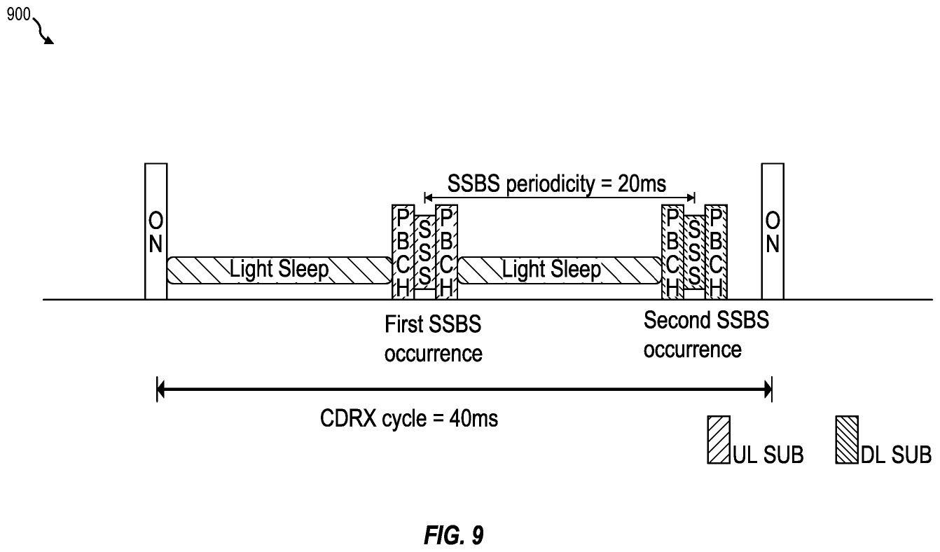

In some cases, the UE may support UL and DL beam decoupling (i.e., use different beams for UL and DL operations), which may require loop tracking on two different beams (e.g., UL and DL beams/SUBs of the UE) during the CDRX cycle. This may need two SSBSs wake-up for the UE during the CDRX cycle periodically, which consumes extra power by a battery of the UE for the SSBS wake-up. For example, as illustrated in a diagram 900 of FIG. 9, the UE may wake-up for different SSBS occurrences (e.g., first and second SSBS occurrences to receive one or more SSBs, where each SSB includes at least a physical broadcast channel (PBCH) and a secondary synchronization signal (SSS)) during the CDRX cycle, to perform the loop tracking tasks on the two different beams (e.g., UL SUB and DL SUB). Waking up multiple times for the multiple SSBSs may increase power consumption at the UE, especially when the UE is operating in the CDRX mode.

### Aspects Related to Single SSB Wake-Up for Loop Tracking on Uplink and Downlink Beams

Aspects of the present disclosure disclosed herein facilitate reducing a number of times a user equipment (UE) operating in a connected-mode discontinuous reception (CDRX) mode may wake-up to receive a reference signal, such as a synchronization signal burst set (SSBS) and, thereby, enable the UE to improve power efficiency while operating in the CDRX mode.

For example, techniques disclosed herein may enable the UE to perform or exploit uplink and downlink loop tracking tasks using a single synchronization signal block (SSB) during an SSBS, as opposed to by using multiple SSBs during multiple SSBSs, to save power. For example, the UE may use a downlink serving beam (e.g., a downlink beam the UE is currently using) as an input to loop tracking on the single SSB for automatic gain control (AGC) loop, time tracking loop (TTL), frequency tracking loop (FTL), power delay profile (PDP) loop, and/or channel estimation loop tasks. The FTL may use physical broadcast channel (PBCH)-demodulation reference signal (DMRS) associated with the single SSB. The AGC loop, the TTL, and the PDP loop may use PBCH-DMRS or re-encoded PBCH associated with the single SSB, which may save a secondary synchronization signal (SSS) symbol on the single SSB for other usage. The UE may use an uplink serving beam (e.g., an uplink beam the UE is currently using) in the SSS symbol on the single SSB of the SSBS for the loop tracking, in order to measure a timing offset (TO) on the single SSB.

In some cases, the UE may perform/implement uplink timing adjustment based on both a TTL offset (e.g., measured from/based on the downlink serving beam) and the TO (e.g., measured from/based on the uplink serving beam), which may be needed for uplink transmissions. The UE may then send the uplink transmissions, in accordance with the uplink timing adjustment.

Particular aspects of the subject matter described in this disclosure can be implemented to realize one or more of the following potential advantages. In some examples, the described techniques may reduce power consumption by the UE and, thereby, may enable the UE to improve the power efficiency while operating in the CDRX mode. For example, when the UE may wake-up for fewer SSBS occurrences, the increased time between wake-up SSBS occurrences helps to improve the power efficiency at the UE.

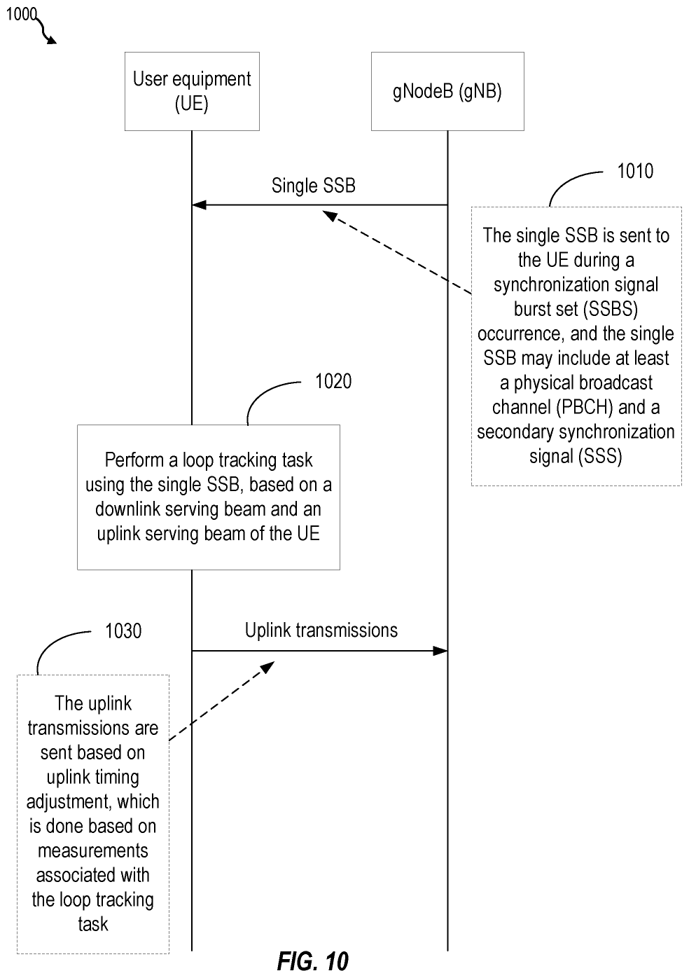

The techniques proposed herein for managing synchronization of loops of the UE using the single SSB may be understood with reference to FIG. 10-FIG. 13.

FIG. 10 depicts a call flow diagram 1000 illustrating example communication among a UE and a network entity (e.g., a gNB) for managing synchronization of loops of the UE using a single SSB. The UE shown in FIG. 10 may be an example of the UE 104 depicted and described with respect to FIG. 1 and FIG. 3. The gNB depicted in FIG. 10 may be an example of the BS 102 depicted and described with respect to FIG. 1 and FIG. 3, or the disaggregated BS depicted and described with respect to FIG. 2.

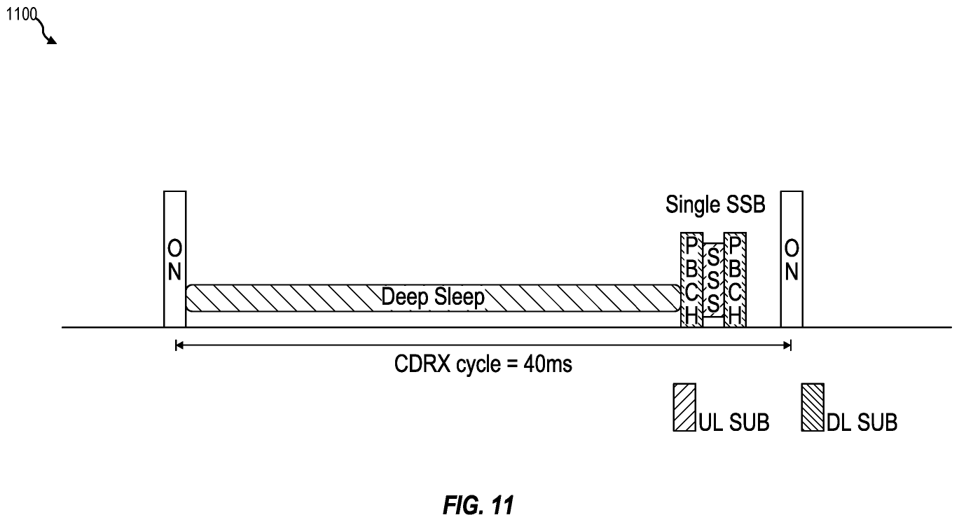

As indicated at 1010, the UE receives a single SSB during an SSBS occurrence. For example, as illustrated in a diagram 1100 of FIG. 11, the UE may receive the single SSB during an OFF duration of a CDRX cycle. The single SSB may include at least a PBCH and an SSS.

In certain aspects, the SSBS occurrence may last 0.5 ms window (e.g., two SSBS occurrences may occur within a 1 ms period). In certain aspects, the SSBS occurrence may include SSBS with one or more SSBs (e.g., ranging from 0 to 13). For example, the SSBS may include 2 SSBs, and each SSB corresponds to a different UE beam. That is, each SSB may potentially be transmitted on a different beam.

Although the following description may provide examples based on the UE performing tasks “during” the SSBS occurrence, it should be appreciated that the examples descripted herein may be applicable to examples in which the UE performs the respective task “based on” the SSBS occurrence and/or “using” the SSBS occurrence. For example, the UE may perform (and/or complete) a task after the SSBS occurrence but based on (and/or using) measurements that were made during the SSBS occurrence. Furthermore, although the following description may provide examples based on 5G/new radio (NR), it should be appreciated that the concepts described herein may be applicable to other communication technologies. For example, the concepts described herein may be applicable to other wireless technologies in which a UE may operate in a CDRX mode.

Referring back to FIG. 10, as indicated at 1020, the UE performs one or more loop tracking tasks using the single SSB, based on a downlink serving beam and an uplink serving beam of the UE.

In certain aspects, the UE may periodically perform the one or more loop tracking tasks after a number of CDRX cycles (e.g., every 1/2/4 CDRX cycles depending on a panic mode). For example, after camping on a serving cell, the UE may determine that a neighboring cell has a better signal quality than the serving cell. For example, the serving cell may have inferior signal quality due to subpar communication channels or UE mobility (e.g., the UE being at the edge of the serving cell). The UE may then enter the panic mode (e.g., after a small duration or a few CDRX cycles) and attempt to identify the neighboring cell with a better signal quality than that of the serving cell.

In certain aspects, as illustrated in a diagram 1100 of FIG. 11, the UE may use the downlink serving beam in the PBCH of the single SSB, as an input for the one or more loop tracking tasks, to measure at least TTL offset for uplink transmissions.

In certain aspects, as illustrated in a diagram 1100 of FIG. 11, the UE may use the uplink serving beam in a symbol for the SSS of the single SSB, as the input for the one or more loop tracking tasks, to measure at least TO for the uplink transmissions.

In certain aspects, the UE may adjust timing for the uplink transmissions based on measurements associated with the one or more loop tracking tasks. For example, the UE may perform or implement uplink timing adjustment for the uplink transmissions based on the TTL offset and the TO.

In one example, a loop tracking task may correspond to synchronization of one or more AGC loops of the UE. In another example, the loop tracking task may correspond to synchronization of one or more TTLs of the UE. In another example, the loop tracking task may correspond to synchronization of one or more FTLs of the UE. In another example, the loop tracking task may correspond to synchronization of one or more PDP loops of the UE. In another example, the loop tracking task may correspond to synchronization of one or more channel estimation loops of the UE.

Referring back to FIG. 10, as indicated at 1030, the UE sends the uplink transmissions to the gNB. The uplink transmissions are sent by the UE based on the uplink timing adjustment, which is done by the UE based on the measurements associated with the one or more loop tracking tasks.

### Example Method for Wireless Communications at a User Equipment (UE)

FIG. 12 shows an example of a method 1200 for wireless communications at a user equipment (UE), such as the UE 104 of FIG. 1 and FIG. 3.

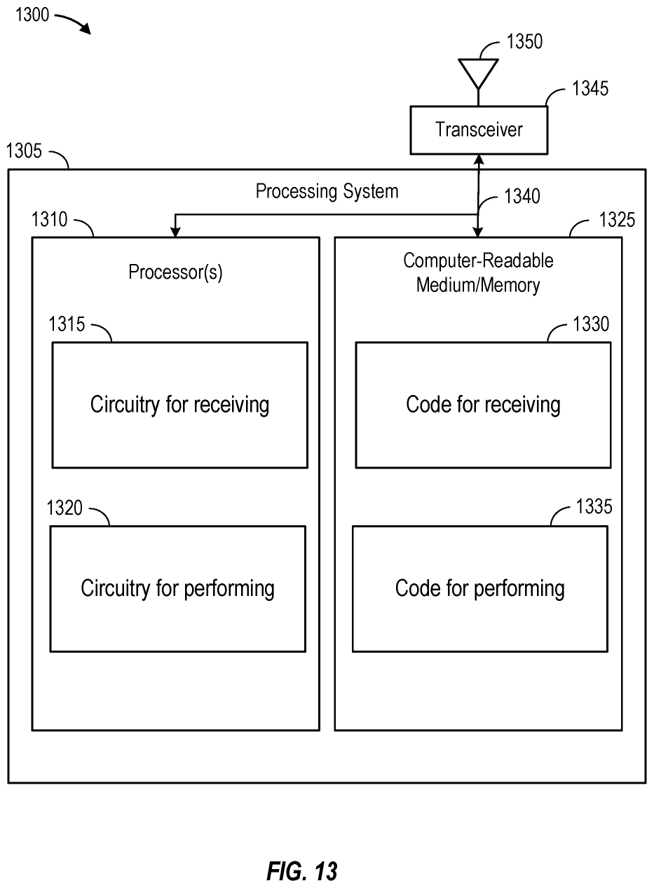

Method 1200 begins at step 1210 with receiving a single synchronization signal block (SSB) during a synchronization signal burst set (SSBS) occurrence. The single SSB includes at least a physical broadcast channel (PBCH) and a secondary synchronization signal (SSS). In some cases, the operations of this step refer to, or may be performed by, circuitry for receiving and/or code for receiving as described with reference to FIG. 13.

Method 1200 then proceeds to step 1220 with performing a loop tracking task using the single SSB, based on a downlink serving beam and an uplink serving beam of the UE. In some cases, the operations of this step refer to, or may be performed by, circuitry for performing and/or code for performing as described with reference to FIG. 13.

In certain aspects, the performing includes using the downlink serving beam in the PBCH, as an input for the loop tracking task, to measure at least a time tracking loop (TTL) offset for an uplink transmission.

In certain aspects, the performing includes using the uplink serving beam in a symbol for the SSS, as an input for the loop tracking task, to measure at least a timing offset for an uplink transmission.

In certain aspects, the performing includes adjusting timing for an uplink transmission based on measurements associated with the loop tracking task.

In certain aspects, the receiving includes receiving the single SSB during an OFF duration of a connected-mode discontinuous reception (CDRX) cycle.

In certain aspects, the performing includes periodically performing the loop tracking task after a number of CDRX cycles.

In certain aspects, the loop tracking task corresponds to synchronization of one or more automatic gain control (AGC) loops of the UE.

In certain aspects, the loop tracking task corresponds to synchronization of one or more time tracking loops (TTLs) of the UE.

In certain aspects, the loop tracking task corresponds to synchronization of one or more frequency tracking loops (FTLs) of the UE.

In certain aspects, the loop tracking task corresponds to synchronization of one or more power delay profile (PDP) loops of the UE.

In certain aspects, the loop tracking task corresponds to synchronization of one or more channel estimation loops of the UE.

In one aspect, the method 1200, or any aspect related to it, may be performed by an apparatus, such as a communications device 1300 of FIG. 13, which includes various components operable, configured, or adapted to perform the method 1200. The communications device 1300 is described below in further detail.

Note that FIG. 12 is just one example of a method, and other methods including fewer, additional, or alternative steps are possible consistent with this disclosure.

### Example Communications Device

FIG. 13 depicts aspects of an example communications device 1300. In some aspects, communications device 1300 is a user equipment (UE), such as UE 104 described above with respect to FIG. 1 and FIG. 3.

The communications device 1300 includes a processing system 1305 coupled to a transceiver 1345 (e.g., a transmitter and/or a receiver). The transceiver 1345 is configured to transmit and receive signals for the communications device 1300 via an antenna 1350, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. The one or more processors 1310 are coupled to a computer-readable medium/memory 1325 via a bus 1340. In certain aspects, the computer-readable medium/memory 1325 is configured to store instructions (e.g., computer-executable code) that when executed by the one or more processors 1310, cause the one or more processors 1310 to perform the method 1200 described with respect to FIG. 12, and/or any aspect related to it. Note that reference to a processor performing a function of communications device 1300 may include the one or more processors 1310 performing that function of communications device 1300.

In the depicted example, computer-readable medium/memory 1325 stores code (e.g., executable instructions), such as code for receiving 1330 and code for performing 1335. Processing of the code for receiving 1330 and the code for performing 1335 may cause the communications device 1300 to perform the method 1200 described with respect to FIG. 12, and/or any aspect related to it.

The one or more processors 1310 include circuitry configured to implement (e.g., execute) the code stored in the computer-readable medium/memory 1325, including circuitry such as circuitry for receiving 1315 and circuitry for performing 1320. Processing with the circuitry for receiving 1315 and the circuitry for performing 1320 may cause the communications device 1300 to perform the method 1200 described with respect to FIG. 12, and/or any aspect related to it.

Various components of the communications device 1300 may provide means for performing the method 1200 described with respect to FIG. 12, and/or any aspect related to it. For example, means for transmitting, sending or outputting for transmission may include transceivers 354 and/or antenna(s) 352 of the UE 104 illustrated in FIG. 3 and/or the transceiver 1345 and the antenna 1350 of the communications device 1300 in FIG. 13. Means for receiving or obtaining may include transceivers 354 and/or antenna(s) 352 of the UE 104 illustrated in FIG. 3 and/or the circuitry for receiving 1315, the code for receiving 1330, the transceiver 1345 and the antenna 1350 of the communications device 1300 in FIG. 13. Means for performing may include processors, transceivers 354 and/or antenna(s) 352 of the UE 104 illustrated in FIG. 3 and/or the code for performing 1335, the circuitry for performing 1320, the transceiver 1345 and the antenna 1350 of the communications device 1300 in FIG. 13.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 13 is an example, and many other examples and configurations of communication device 1300 are possible.

### Example Clauses

Implementation examples are described in the following numbered clauses:
Clause 1: A method for wireless communications at a user equipment (UE), comprising: receiving a single synchronization signal block (SSB) during a synchronization signal burst set (SSBS) occurrence, wherein the single SSB comprises at least a physical broadcast channel (PBCH) and a secondary synchronization signal (SSS); and performing a loop tracking task using the single SSB, based on a downlink serving beam and an uplink serving beam of the UE.
Clause 2: The method of clause 1, wherein the performing comprises using the downlink serving beam in the PBCH, as an input for the loop tracking task, to measure at least a time tracking loop (TTL) offset for an uplink transmission.
Clause 3: The method of any one of clauses 1-2, wherein the performing comprises using the uplink serving beam in a symbol for the SSS, as an input for the loop tracking task, to measure at least a timing offset for an uplink transmission.
Clause 4: The method of any one of clauses 1-3, wherein the performing comprises adjusting timing for an uplink transmission based on measurements associated with the loop tracking task.
Clause 5: The method of any one of clauses 1-4, wherein the receiving comprises receiving the single SSB during an OFF duration of a connected-mode discontinuous reception (CDRX) cycle.
Clause 6: The method of any one of clauses 1-5, wherein the performing comprises periodically performing the loop tracking task after a number of connected-mode discontinuous reception (CDRX) cycles.
Clause 7: The method of any one of clauses 1-6, wherein the loop tracking task corresponds to synchronization of one or more automatic gain control (AGC) loops of the UE.
Clause 8: The method of any one of clauses 1-7, wherein the loop tracking task corresponds to synchronization of one or more time tracking loops (TTLs) of the UE.
Clause 9: The method of any one of clauses 1-8, wherein the loop tracking task corresponds to synchronization of one or more frequency tracking loops (FTLs) of the UE.
Clause 10: The method of any one of clauses 1-9, wherein the loop tracking task corresponds to synchronization of one or more power delay profile (PDP) loops of the UE.
Clause 11: The method of any one of clauses 1-10, wherein the loop tracking task corresponds to synchronization of one or more channel estimation loops of the UE.
Clause 12: An apparatus, comprising: a memory comprising executable instructions; and one or more processors configured, individually or in any combination, to execute the executable instructions and cause the apparatus to perform a method in accordance with any one of Clauses 1-11.
Clause 13: An apparatus, comprising means for performing a method in accordance with any one of Clauses 1-11.
Clause 14: A non-transitory computer-readable medium comprising executable instructions that, when executed by one or more processors of an apparatus, cause the apparatus to perform a method in accordance with any one of Clauses 1-11.
Clause 15: A computer program product embodied on a computer-readable storage medium comprising code for performing a method in accordance with any one of Clauses 1-11.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
a memory comprising instructions; and
one or more processors configured, individually or in any combination, to execute the instructions and cause the apparatus to:
receive a single synchronization signal block (SSB) during a synchronization signal burst set (SSBS) occurrence, wherein the single SSB comprises at least a physical broadcast channel (PBCH) and a secondary synchronization signal (SSS); and
perform a loop tracking task using the single SSB, based on a downlink serving beam and an uplink serving beam of the UE.

2. The apparatus of claim 1, wherein the perform comprises use the downlink serving beam in the PBCH, as an input for the loop tracking task, to measure at least a time tracking loop (TTL) offset for an uplink transmission.

3. The apparatus of claim 1, wherein the perform comprises use the uplink serving beam in a symbol for the SSS, as an input for the loop tracking task, to measure at least a timing offset for an uplink transmission.

4. The apparatus of claim 1, wherein the perform comprises adjust timing for an uplink transmission based on measurements associated with the loop tracking task.

5. The apparatus of claim 1, wherein the receive comprises receive the single SSB during an OFF duration of a connected-mode discontinuous reception (CDRX) cycle.

6. The apparatus of claim 1, wherein the perform comprises periodically perform the loop tracking task after a number of connected-mode discontinuous reception (CDRX) cycles.

7. The apparatus of claim 1, wherein the loop tracking task corresponds to synchronization of one or more automatic gain control (AGC) loops of the UE.

8. The apparatus of claim 1, wherein the loop tracking task corresponds to synchronization of one or more time tracking loops (TTLs) of the UE.

9. The apparatus of claim 1, wherein the loop tracking task corresponds to synchronization of one or more frequency tracking loops (FTLs) of the UE.

10. The apparatus of claim 1, wherein the loop tracking task corresponds to synchronization of one or more power delay profile (PDP) loops of the UE.

11. The apparatus of claim 1, wherein the loop tracking task corresponds to synchronization of one or more channel estimation loops of the UE.

12. A method for wireless communications at a user equipment (UE), comprising:
receiving a single synchronization signal block (SSB) during a synchronization signal burst set (SSBS) occurrence, wherein the single SSB comprises at least a physical broadcast channel (PBCH) and a secondary synchronization signal (SSS); and
performing a loop tracking task using the single SSB, based on a downlink serving beam and an uplink serving beam of the UE.

13. The method of claim 12, wherein the performing comprises using the downlink serving beam in the PBCH, as an input for the loop tracking task, to measure at least a time tracking loop (TTL) offset for an uplink transmission.

14. The method of claim 12, wherein the performing comprises using the uplink serving beam in a symbol for the SSS, as an input for the loop tracking task, to measure at least a timing offset for an uplink transmission.

15. The method of claim 12, wherein the performing comprises adjusting timing for an uplink transmission based on measurements associated with the loop tracking task.

16. The method of claim 12, wherein the receiving comprises receiving the single SSB during an OFF duration of a connected-mode discontinuous reception (CDRX) cycle.

17. The method of claim 12, wherein the performing comprises periodically performing the loop tracking task after a number of connected-mode discontinuous reception (CDRX) cycles.

18. The method of claim 12, wherein the loop tracking task corresponds to synchronization of one or more automatic gain control (AGC) loops of the UE.

19. The method of claim 12, wherein the loop tracking task corresponds to synchronization of one or more time tracking loops (TTLs) of the UE.

20. A non-transitory computer-readable medium comprising instructions that, when executed by one or more processors of a user equipment (UE), cause the UE to perform a method of wireless communications, comprising:
receiving a single synchronization signal block (SSB) during a synchronization signal burst set (SSBS) occurrence, wherein the single SSB comprises at least a physical broadcast channel (PBCH) and a secondary synchronization signal (SSS); and
performing a loop tracking task using the single SSB, based on a downlink serving beam and an uplink serving beam of the UE.
